(19) United States
(12) Patent Application Publication
(10) Pub. No.: US 2024/0427622 A1
(43) Pub. Date: Dec. 26, 2024

(54) Autonomous Deprovisioning of Virtual Machines

(71) Applicant: International Business Machines Corporation, Armonk, NY (US)

(72) Inventors: Enrico Regge, Stuttgart (DE); Simon Daniel Moser, Gärtringen (DE); Peter Gerstl, Holzgerlingen (DE); Tareq Al-Maamari, Böblingen (DE); Sugandha Agrawal, Stuttgart (DE); Michael Beck, Bad Teinach-Zavelstein (DE); Michael Behrendt, Sindelfingen-Maichingen (DE)

(21) Appl. No.: 18/341,391

(22) Filed: Jun. 26, 2023

(51) Int. Cl. G06F 9/455

(52) U.S. Cl. CPC G06F 9/45558; G06F 2009/45575

(57) ABSTRACT

A computer implemented method for deprovisioning a virtual machine is provided. A number of processor units initializes a deprovisioning agent within the virtual machine. The number of processor units monitors a set of metrics in the virtual machine using the deprovisioning agent. The number of processor units deprovisions the virtual machine using the deprovisioning agent in response to the set of metrics meeting a set of criteria for deprovisioning the virtual machine.

### BACKGROUND

The disclosure relates generally to an improved computer system and more specifically to automatically deprovisioning virtual machines.

A virtual machine is a virtualization or emulation of a computer system. Virtual machines are based on computer architectures that provide the functionality of physical computers. Virtual machines have become the backbone of cloud-focused scalars, which are providers of cloud computing services on a large scale. These cloud-focused scalars typically operate large data centers and can deliver vast amounts of computing resources.

Virtual machines are often treated as a resource that remains operational for a long time. The virtual machine can be customized and used through target end points, such as IP addresses and host names. With these types of virtual machines, the end points rarely change and the customer deploy and maintains operating systems and applications in the virtual machine. Users have control over the virtual infrastructure including configuring the operating system, installing software, and applying security patches.

Serverless computing has become more popular as a cloud computing model. Serverless computing is also known as a Function-as-a-Service (FaaS). In providing serverless computing services, a cloud provider dynamically allocates computing resources. With serverless computing systems, virtual machines can be used to provide for the execution of serverless applications or functions. Virtual machines allow for increased flexibility because virtual machines can be automatically scaled to take into account workload requests for a service computing system. Virtual machines can be provisioned and deprovisioned based on the requests for services. Virtual machines in a serverless computing system are used for a short period of time relative to virtual machines provisioned for customers. Virtual machines may run for a few hours, a few days, or few weeks to process workloads in the serverless computing system. As a result, the use of virtual machines can increase the ability for efficiently resourcing allocation and optimizing costs.

### SUMMARY

According to one illustrative embodiment, a computer implemented method for deprovisioning a virtual machine is provided. A number of processor units initializes a deprovisioning agent within the virtual machine. The number of processor units monitors a set of metrics in the virtual machine using the deprovisioning agent. The number of processor units deprovisions the virtual machine using the deprovisioning agent in response to the set of metrics meeting a set of criteria for deprovisioning the virtual machine. According to other illustrative embodiments, a computer system and a computer program product for deprovisioning a virtual machine are provided.

### BRIEF DESCRIPTION OF THE DRAWINGS

FIG. 1 is a block diagram of a computing environment in accordance with an illustrative embodiment;

FIG. 2 is a block diagram of a virtual machine environment in accordance with an illustrative embodiment;

FIG. 3 is a process flow for a deprovisioning agent in a virtual machine in accordance with an illustrative embodiment;

FIG. 4 is a timeline illustrating deprovisioning of a virtual machine using a deprovisioning agent in accordance with an illustrative embodiment;

FIG. 5 is a flowchart of a process for deprovisioning a virtual machine in accordance with an illustrative embodiment;

FIG. 6 is a flowchart of a process for initializing a deprovisioning agent in accordance with an illustrative embodiment;

FIG. 7 is a flowchart of a process for creating a snapshot in accordance with an illustrative embodiment;

FIG. 8 is a flowchart of a process for monitoring a virtual machine in accordance with an illustrative embodiment;

FIG. 9 is a flowchart of a process for deprovisioning a virtual machine in accordance with an illustrative embodiment; and

FIG. 10 is a block diagram of a data processing system in accordance with an illustrative embodiment.

### DETAILED DESCRIPTION

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

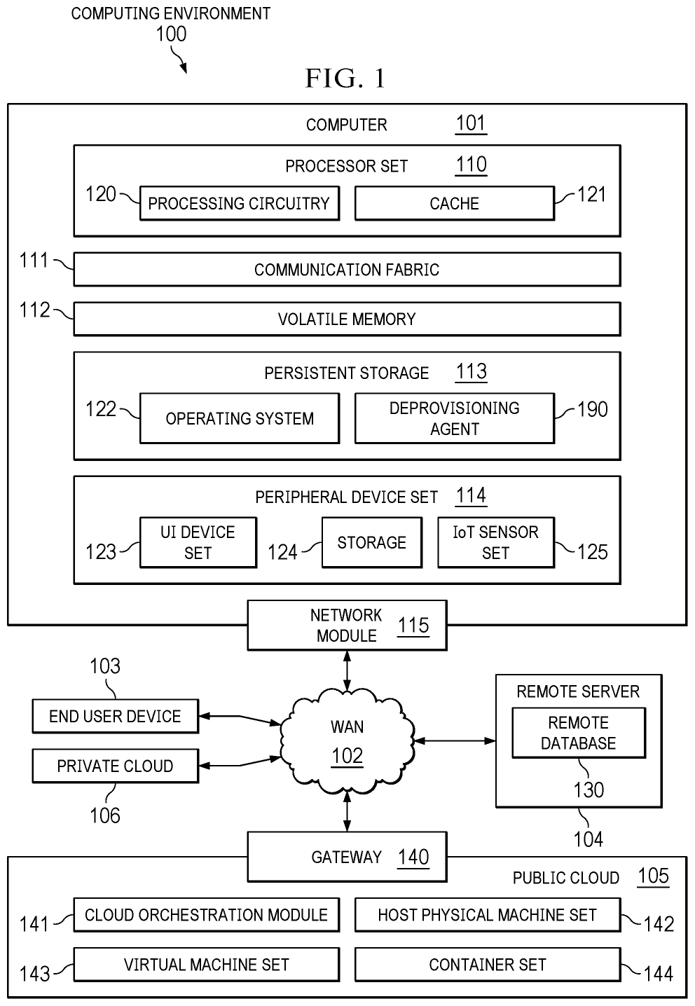

With reference now to the figures in particular with reference to FIG. 1, a block diagram of a computing environment is depicted in accordance with an illustrative embodiment. Computing environment 100 contains an example of an environment for the execution of at least some of the computer code involved in performing the inventive methods, such as deprovisioning agent 190. In addition to deprovisioning agent 190, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and deprovisioning agent 190, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in deprovisioning agent 190 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and storage devices. Operating system 122 may take several forms, such as various known proprietary operating systems or open source Portable Operating System Interface-type operating systems that employ a kernel. The code included in deprovisioning agent 190 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The illustrative embodiments recognize and take into account a number of considerations as described herein. Currently, virtual machines used for serverless computing are managed using a centralized controller. The centralized controller controls the lifecycle of virtual machines. This centralized controller automatically provisions virtual machines and is also capable of deprovisioning the virtual machines when those virtual machines are no longer needed.

For example, when a request is received for workload, the centralized controller communicates to a node to create a virtual machine and assign a job to the virtual machine. The centralized controller also ensures that the virtual machine continues to run to perform the workload, receives an indication that the workload has been completed, and assigns another workload or deprovisions the virtual machine. These workloads can include simulations, scientific calculations, and training machine learning models. Using a centralized controller to monitor and control deprovisioning of virtual machines increases overhead. Resources are needed to set up communications for the centralized controller create, monitor, and control the virtual machines. Plus, the centralized controller can be a bottleneck when many virtual machines are managed by the central controller. For example, if a workload requires a thousand virtual machines, the centralized controller manages synchronizing the virtual machines. As a result, the centralized controller becomes a bottleneck.

With a decentralized system for the management the deprovisioning of virtual machines, the setup of virtual machines is simplified. For example, many virtual machines can be set up without needing to establish network connectivity between a central controller and the nodes with the virtual machines. Additionally, reduced security risks are present because a reduced attack surface. For example, the virtual machines and the deprovisioning agents are only present for a short period of time. Further, lower operational costs are present because a centralized controller is not needed to monitor the processing of workloads on the different virtual machines and maintenance and updates to virtual machines are not needed. Further a bottleneck is also not present because a centralized controller is not needed to manage the virtual machines.

Thus, the illustrative examples provide a computer implemented method, apparatus, computer system, and computer program product that enables managing deprovisioning of virtual machines autonomously. The deprovisioning can be controlled without needing supervision or management by a centralized controller. Instead, components within the virtual machine determine when the virtual machine should be deprovisioned.

In one illustrative example, a computer implemented method manages deprovisioning a virtual machine. A number of processor units initializes a deprovisioning agent within the virtual machine. The number of processor units monitors a set of metrics in the virtual machine using the deprovisioning agent. The number of processor units deprovisions the virtual machine using the deprovisioning agent in response to the set of metrics meeting a set of criteria for deprovisioning the virtual machine.

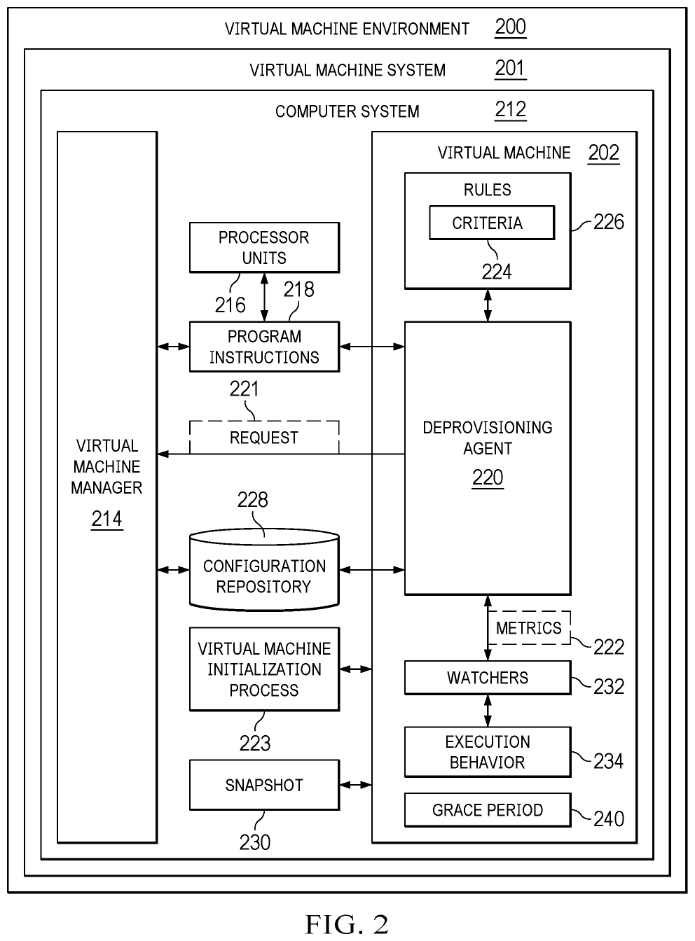

With reference now to FIG. 2, a block diagram of a virtual machine environment is depicted in accordance with an illustrative embodiment. In this illustrative example, virtual machine environment 200 includes components that can be implemented in hardware such as the hardware shown in computing environment 100 in FIG. 1. For example, virtual machine system 201 can manage the lifecycle of virtual machine 202. In this example, virtual machine system 201 can also automatically deprovision virtual machine 202 when virtual machine 202 has completed performing a workload and is no longer needed.

Virtual machine 202 can be implemented in a number of different environments. For example, virtual machine 202 can be located in a serverless computing system where virtual machines exist for shorter periods of time as compared to virtual machines. Virtual machine 202 can also be located in a desktop virtualization system, a server virtualization system, or other types of environments.

In this illustrative example, virtual machine system 201 comprises computer system 212, virtual machine manager 214, and deprovisioning agent 220. Virtual machine manager 214 is located in computer system 212. Deprovisioning agent 220 can be implemented using deprovisioning agent 190 in FIG. 1.

Virtual machine manager 214 and deprovisioning agent 220 can be implemented in software, hardware, firmware or a combination thereof. When software is used, the operations performed by deprovisioning agent 220 can be implemented in program instructions configured to run on hardware, such as a processor unit. When firmware is used, the operations performed by deprovisioning agent 220 can be implemented in program instructions and data and stored in persistent memory to run on a processor unit. When hardware is employed, the hardware can include circuits that operate to perform the operations in deprovisioning agent 220.

In the illustrative examples, the hardware can take a form selected from at least one of a circuit system, an integrated circuit, an application specific integrated circuit (ASIC), a programmable logic device, or some other suitable type of hardware configured to perform a number of operations. With a programmable logic device, the device can be configured to perform the number of operations. The device can be reconfigured at a later time or can be permanently configured to perform the number of operations. Programmable logic devices include, for example, a programmable logic array, a programmable array logic, a field programmable logic array, a field programmable gate array, and other suitable hardware devices. Additionally, the processes can be implemented in organic components integrated with inorganic components and can be comprised entirely of organic components excluding a human being. For example, the processes can be implemented as circuits in organic semiconductors.

As used herein, “a number of” when used with reference to items, means one or more items. For example, “a number of operations” is one or more operations.

Further, the phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, or item C” may include item A, item A and item B, or item B. This example also may include item A, item B, and item C or item B and item C. Of course, any combination of these items can be present. In some illustrative examples, “at least one of” can be, for example, without limitation, two of item A; one of item B; and ten of item C; four of item B and seven of item C; or other suitable combinations.

Computer system 212 is a physical hardware system and includes one or more data processing systems. When more than one data processing system is present in computer system 212, those data processing systems are in communication with each other using a communications medium. The communications medium can be a network. The data processing systems can be selected from at least one of a computer, a server computer, a tablet computer, or some other suitable data processing system.

As depicted, computer system 212 includes a number of processor units 216 that are capable of executing program instructions 218 implementing processes in the illustrative examples. In other words, program instructions 218 are computer readable program instructions.

As used herein, a processor unit in the number of processor units 216 is a hardware device and is comprised of hardware circuits such as those on an integrated circuit that respond to and process instructions and program code that operate a computer. A processor unit can be implemented using processor set 110 in FIG. 1. When the number of processor units 216 executes program instructions 218 for a process, the number of processor units 216 can be one or more processor units that are in the same computer or in different computers. In other words, the process can be distributed between processor units 216 on the same or different computers in computer system 212.

Further, the number of processor units 216 can be of the same type or different types of processor units. For example, the number of processor units 216 can be selected from at least one of a single core processor, a dual-core processor, a multi-processor core, a general-purpose central processing unit (CPU), a graphics processing unit (GPU), a digital signal processor (DSP), or some other type of processor unit.

In this illustrative example, virtual machine manager 214 provisions virtual machine 202. In provisioning virtual machine 202, virtual machine manager 214 allocates resources and obtains configuration information from configuration repository 228 for use in provisioning virtual machine 202. This configuration information also includes information to initialize deprovisioning agent 220 within virtual machine 202.

As part of initializing virtual machine 202, virtual machine 202 initializes deprovisioning agent 220 within the virtual machine 202. In one illustrative example, deprovisioning agent 220 can be initialized within virtual machine 202 using virtual machine initialization process 223 such as a cloud-init to install deprovisioning agent 220 in virtual machine 202. Information needed to install deprovisioning agent 220 is located in configuration repository 228.

Virtual machine 202 can retrieve a set of rules 226 implementing the set of criteria 224 from configuration repository 228. In another example, the set of rules 226 can be received with a workload submission. Virtual machine 202 can configure deprovisioning agent 220 using the set of rules 226 retrieved from configuration repository 228.

As used herein, a “set of” when used with reference items means one or more items. For example, a set of rules is one or more rules.

Deprovisioning agent 220 monitors a set of metrics 222 in virtual machine 202. In one illustrative example, the monitoring can be performed using watchers 232. With the use of watchers 232, a set of watchers 232 can observe execution behavior 234 of virtual machine 202.

Deprovisioning agent 220 can monitor the set of metrics 222 generated by the set of watchers 232 observing execution behavior 234. In this example, the set of watchers 232 return the set of metrics 222 to deprovisioning agent 220.

The set of watchers 232 can be any component or construct that can monitor execution behavior 234 of virtual machine 202. For example, a watcher can be, for example, a real time system monitoring tool, a custom program, or other type of component. As another example, a watcher can be implemented using a “top” command used in systems such as Unix.

In monitoring execution behavior 234, the set of watchers 232 can generate the set of metrics 222 based on execution behavior 234 observed by the set of watchers 232. For example, execution behavior 234 may use different amounts of processor resources for storage. This usage of these resources in execution behavior 234 can be used to determine a set of metrics 222 such as processor usage and storage usage.

In the illustrative example, individual watchers in watchers 232 can be configured to monitor for different aspects of execution behavior 234. For example, one watcher can monitor processor usage while another watcher can monitor input/output activity. In other examples, a watcher can monitor for multiple aspects of execution behavior 234.

Deprovisioning agent 220 applies the set of metrics 222 received from the set of watchers 232 to a set of rules 226 implementing the set of criteria 224. With the application of the set of metrics 222 to the set of rules 226, deprovisioning agent 220 can determine whether the set of criteria 224 has been met to deprovision virtual machine 202. In this example, when the set of metrics 222 takes the form of processor usage and storage usage, these metrics can be used in the set of rules 226 to determine whether criteria 224 met indicating that virtual machine 202 should be deprovisioned.

The set of rules 226 can take various forms and have different levels of complexity. For example, the set of rules 226 can indicate that virtual machine 202 is to be deprovisioned when the workload is complete. In another example, the set of rules 226 may also include both the workload being completed and an output file being generated. In yet another illustrative example, the set of rules 226 may include the workload being completed, output file having a name “abc.doc” being generated, and an upload of the output file being completed to a selected repository or other location.

As another example, a rule in the set of rules 226 can be whether a particular process ID is running. In still another illustrative example, a rule can be whether a selected amount of incoming traffic on a specific port for a specific period of time is present.

In another example, the rule can be whether the processor has been idle or a specific period of time. In yet another example, the rule can be whether the processor utilization is below a selected percentage for a given period of time. These and other rules can be used to implement the set of rules 226 to determine whether criteria 224 have been met to deprovision virtual machine 202.

In this illustrative example, deprovisioning agent 220 sends request 221 to deprovision of virtual machine 202 in response to the set of metrics 222 meeting a set of criteria 224 for deprovisioning virtual machine 202. Virtual machine manager 214 deprovisions virtual machine 202 in response to receiving this request from deprovisioning agent 220. In this example, deprovisioning virtual machine 202 involves shutting down virtual machine 202 and releasing resources for virtual machine 202. Part of releasing resources can involve training those resources to a pool for reuse.

In deprovisioning virtual machine 202, grace period 240 can be used in some illustrative examples. For example, deprovisioning agent 220 can start grace period 240 in response to the set of metrics 222 meeting the set of criteria 224 for deprovisioning the virtual machine. Deprovisioning agent 220 sends request 221 to virtual machine manager 214 to deprovision virtual machine 202 in response to grace period 240 ending.

In the illustrative example, grace period 240 can allow for other activities to occur after virtual machine 202 is finished processing a workload. For example, grace period 240 may provide time for an output file to be generated sent to a location outside of virtual machine 202. This location can be a snapshot repository, a database, a data store, a memory, or some other suitable location.

Further, deprovisioning agent 220 can optionally create snapshot 230 of virtual machine 202 prior to virtual machine 202 being deprovisioned in response to meeting the set of criteria for deprovisioning the virtual machine. In this depicted example, snapshot 230 can take a number of different forms. For example, snapshot 230 can be a snapshot of the workload, the entire virtual machine, or other information in virtual machine 202.

Thus, virtual machine 202 can be managed using deprovisioning agent 220. With deprovisioning agent 220, virtual machine manager 214 does not need to manage the operation of virtual machine 202 directly. Instead, deprovisioning agent 220 located within virtual machine environment 200 can determine when to deprovision virtual machine 202. Deprovisioning agent 220 runs independently within virtual machine 202. Virtual machine manager 214 does not need to monitor virtual machine 202 to determine when virtual machine 202 should be deprovisioned. Instead, deprovisioning agent 220 can send request 221 to virtual machine manager 214 when set of criteria 224 for deprovisioning purge machine 202 has been met.

In one illustrative example, one or more solutions are present that overcome a problem with efficiently managing virtual machines. As a result, one or more solutions in the different illustrative examples may provide an ability to automatically deprovision virtual machines that have finished processing workloads without needing a centralized manager is currently used. In the different illustrative examples, a deprovisioning agent is initialized within the virtual machine and manages deprovisioning that virtual machine.

With this use of a deprovisioning agent within a virtual machine, the virtual machine can be managed without needing external network connectivity for monitoring and management of the virtual machine. This deprovisioning agent monitors metrics and applies as metrics to a set of rules to determine whether criteria are met to deprovision the virtual machine. The monitoring of these metrics can be performed through watchers, which are processes, tools, or other constructs that can monitor execution behavior of the virtual machine.

Computer system 212 can be configured to perform at least one of the steps, operations, or actions described in the different illustrative examples using software, hardware, firmware or a combination thereof. As a result, computer system 212 operates as a special purpose computer system in which deprovisioning agent 220 in computer system 212 enables deprovisioning a virtual machine when the virtual machine is no longer needed without needing an external central controller. In these examples, this deprovisioning can occur when the virtual machine has completed processing a workload. In particular, deprovisioning agent 220 transforms computer system 212 into a special purpose computer system as compared to currently available general computer systems that do not have virtual machine manager 214.

In the illustrative example, the use of deprovisioning agent 220 in computer system 212 integrates processes into a practical application for deprovisioning virtual machines using deprovisioning agents within the virtual machines to increase the performance of computer system 212. In this example, the increase in performance can result from increased availability of resources to perform workloads. In other words, deprovisioning agent 220 in computer system 212 is directed to a practical application of processes integrated into deprovisioning agent 220 in computer system 212 in which deprovisioning agent 220 monitors the execution behavior of the virtual machine. This deprovisioning agent deprovisions virtual machine once a set of criteria is met. The deprovision can be performed by deprovisioning agent 220 sending request 221 to virtual machine manager 214 to deprovision virtual machine 202.

The illustration of virtual machine environment 200 in FIG. 2 is not meant to imply physical or architectural limitations to the manner in which an illustrative embodiment can be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

For example, one or more virtual machines may be present within computer system 212 in addition to virtual machine 202. The deprovisioning of these additional virtual machines can also be managed using deprovisioning agents running within those virtual machines. These other virtual machines can use the same or different rules obtained from configuration repository 228, through workload requests or other types of input. In other words, different virtual machines can use different criteria to determine when those virtual machines should be deprovisioned. In another example, configuration repository 228 can be checked while virtual machine 202 runs to obtain new sets of rules. In this manner, the roles that can be changed after a virtual machine has already started processing a workload.

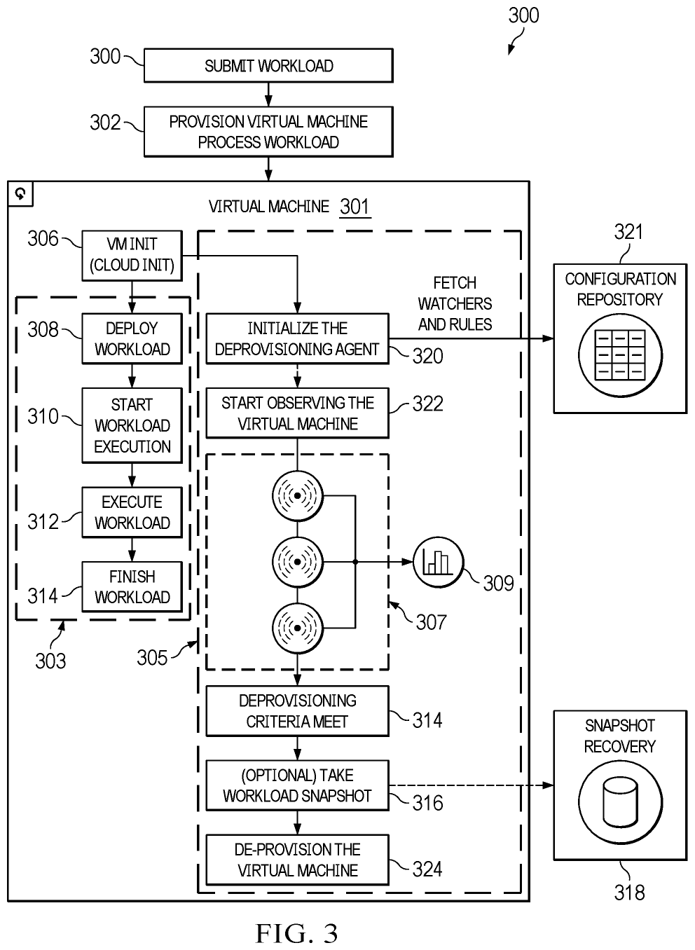

With reference next to FIG. 3, a process flow for a deprovisioning agent in a virtual machine is depicted in accordance with an illustrative embodiment. This process flow can be implemented using virtual machine system 201 with deprovisioning agent 220 in FIG. 2. In this example, the process flow 300 begins with submission of a workload in block 302. Provisioning begins to initialize virtual machine 301 to process the workload in block 304.

In this example, Vm-init occurs in block 306 and is the initialization of virtual machine 301. In this initialization, configurations of resources are prepared to start virtual machine 301. In this depicted example, the particular type of Vm-init can be cloud-init in block 306. In this example, cloud-init enables the automatic configuration and customization of virtual machine 301 when virtual machine 301 is used in a cloud environment.

After initialization of virtual machine 301, workload subflow 303 in process flow 300 illustrates the steps that virtual machine 301 performs in processing the workload. Workload subflow 303 illustrates the steps involved in monitoring and deprovisioning virtual machine 301.

In workload subflow 303, the workload is deployed in block 308 and workload execution starts in block 310. The workload is executed in block 312 and execution of the workload finishes in block 314.

In monitoring subflow 305, the deprovisioning agent is initialized in block 320. In this example the initialization can be performed using information from configuration repository 321. For example, configuration repository 321 can include a set of rules used by the deprovisioning agent to determine whether a set of criteria met to deprovision virtual machine 301.

The deprovisioning agent starts observing virtual machine 301 in block 322. In this example, this observation is an observation of execution behavior of virtual machine 301 and can be made by receiving metrics from watchers 307. In this example, watchers 307 can monitor metrics 309 in virtual machine 301. These metrics can include process identifiers, central processing unit usage, input/output operations, memory usage, and other types of metrics.

In this example, the deprovisioning criteria are met in block 314. This deprovisioning criteria can be met in response to virtual machine 301 finishing execution of the workload in block 314. In this example, a workload snapshot is created in block 316. This workload snapshot is saved to snapshot repository 318. The creation of a snapshot is an optional feature in this example. Virtual machine 301 is then deprovisioned in block 324.

The illustration of process flow 300 in FIG. 3 is provided as an example of one manner in which process flow can occur in monitoring and deprovisioning a virtual machine. This illustration is not meant to limit the manner in which other process flows can be implemented. For example, a grace period can be included in other process flows. In yet another illustrative example, the set of rules can be obtained with the workload to be processed by virtual machine 301.

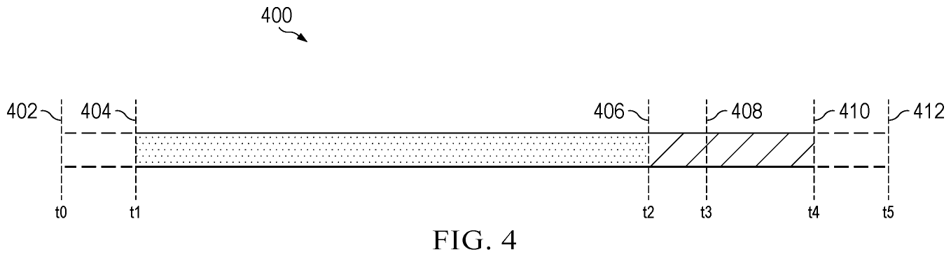

Turning to FIG. 4, a timeline illustrating deprovisioning of a virtual machine using a deprovisioning agent is depicted in accordance with an illustrative embodiment. As depicted, timeline 400 illustrates the lifecycle of a virtual machine with deprovisioning controlled by a deprovisioning agent within the virtual machine.

At time t0 402, the virtual machine is provisioned. Additionally, the deprovisioning agent can also be initialized as part of deprovisioning of the virtual machine. The workload is deployed, and processing starts at time t1 404. The workload completes processing at time t2 406.

The deprovisioning agent detects that the workload has been completed and the virtual machine can be shut down at time t3 408. In this example, a grace period is present in starts at time t3 408. The grace period can enable other steps or activities to be performed from outputs generated by the workload. For example, a file can be uploaded to a location. In some cases, the grace period may be unnecessary when the set of criteria has a level of complexity that include determining when and output has been generated and uploaded to a desired location.

The grace period ends at time t4 410 and the deprovisioning agent begins termination of processes and the deprovisioning of the virtual machine. The virtual machine is shut down and deprovisioned at time t5 412.

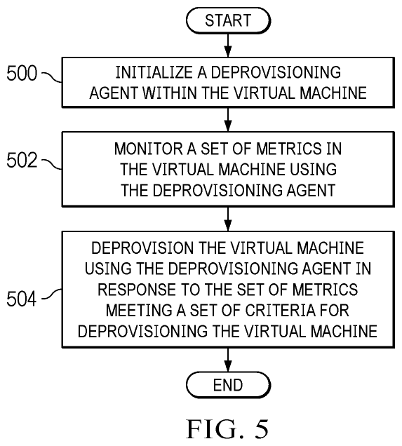

In FIG. 5, a flowchart of a process for deprovisioning a virtual machine is depicted in accordance with an illustrative embodiment. The process in FIG. 5 can be implemented in hardware, software, or both. When implemented in software, the process can take the form of program instructions that are run by one of more processor units located in one or more hardware devices in one or more computer systems. For example, the process can be implemented in virtual machine system 201 in computer system 212 in FIG. 2, which instantiates a deprovisioning agent in virtual machine to monitor and deprovision the virtual machine.

The process begins by initializing a deprovisioning agent within the virtual machine (step 500). The process monitors a set of metrics in the virtual machine using the deprovisioning agent (step 502). In step 502, the set of metrics can be selected from at least one of process IDs, incoming traffic on a port, processor usage, memory usage, input/output operations, TCP/IP connections, or other suitable metrics for determining when a virtual machine has completed a workload or other processing and is no longer needed.

The process deprovisions the virtual machine using the deprovisioning agent in response to the set of metrics meeting a set of criteria for deprovisioning the virtual machine (step 504). The process terminates thereafter. In this example, deprovisioning agent can send a request to the controller to the provision the virtual machine. The monitoring of execution behavior and determination of whether to deprovision the virtual machine is made within the virtual machine by the deprovisioning agent.

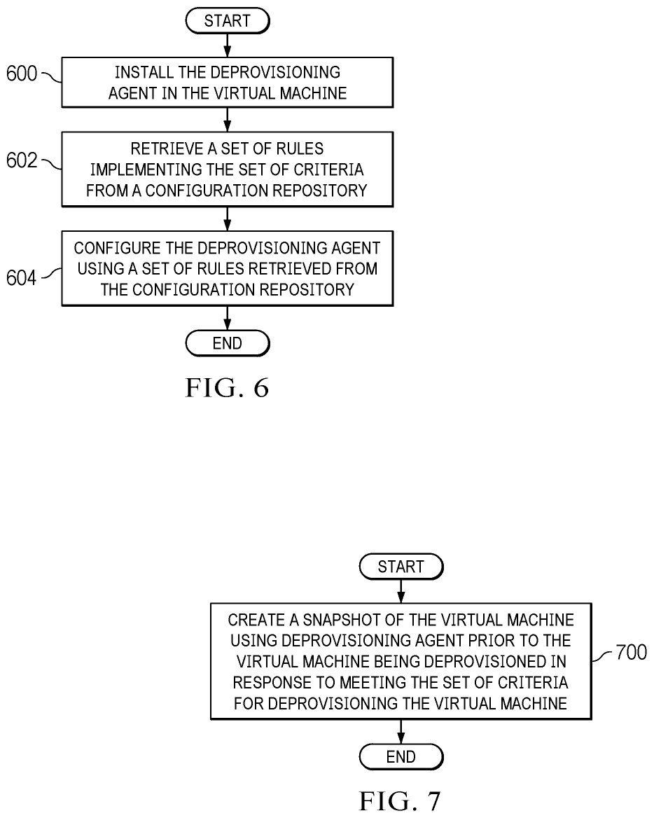

With reference now to FIG. 6, a flowchart of a process for initializing a deprovisioning agent is depicted in accordance with an illustrative embodiment. The process in this flowchart is an example of an implementation for step 500 in FIG. 5.

The process begins by installing the deprovisioning agent in the virtual machine (step 600). The process retrieves a set of rules implementing the set of criteria from a configuration repository (step 602).

The process configures the deprovisioning agent using a set of rules retrieved from the configuration repository (step 604). The process terminates thereafter.

In some examples example, step 602 and step 604 repeated during the operation of the virtual machine. In other words, the rules implementing the criteria can change during the operation of the virtual machine in some illustrative examples.

Next in FIG. 7, a flowchart of a process for creating a snapshot is depicted in accordance with an illustrative embodiment. This figure illustrates an additional step that can be performed with the steps in FIG. 5.

The process creates a snapshot of the virtual machine using deprovisioning agent prior to the virtual machine being deprovisioned in response to meeting the set of criteria for deprovisioning the virtual machine (step 700). The process terminates thereafter.

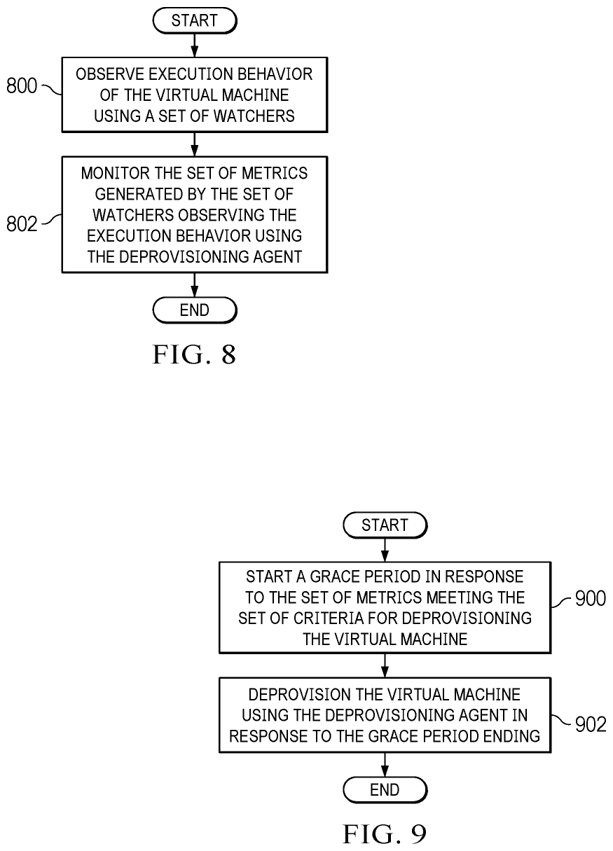

With reference to FIG. 8, a flowchart of a process for monitoring a virtual machine is depicted in accordance with an illustrative embodiment. The process in this figure is an example of an implementation for step 502 in FIG. 5.

The process observes execution behavior of the virtual machine using a set of watchers (step 800). The process monitors the set of metrics generated by the set of watchers observing the execution behavior using the deprovisioning agent (step 802). The process terminates thereafter.

Turning now to FIG. 9, a flowchart of a process for deprovisioning a virtual machine is depicted in accordance with an illustrative embodiment. The process illustrated in this figure is an example of an implementation for step 504 in FIG. 5.

The process begins by starting a grace period in response to the set of metrics meeting the set of criteria for deprovisioning the virtual machine (step 900). The process deprovisions the virtual machine using the deprovisioning agent in response to the grace period ending (step 902). The process terminates thereafter.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step. For example, one or more of the blocks can be implemented as program instructions, hardware, or a combination of the program instructions and hardware. When implemented in hardware, the hardware may, for example, take the form of integrated circuits that are manufactured or configured to perform one or more operations in the flowcharts or block diagrams. When implemented as a combination of program instructions and hardware, the implementation may take the form of firmware. Each block in the flowcharts or the block diagrams can be implemented using special purpose hardware systems that perform the different operations or combinations of special purpose hardware and program instructions run by the special purpose hardware.

In some alternative implementations of an illustrative embodiment, the function or functions noted in the blocks may occur out of the order noted in the figures. For example, in some cases, two blocks shown in succession can be performed substantially concurrently, or the blocks may sometimes be performed in the reverse order, depending upon the functionality involved. Also, other blocks can be added in addition to the illustrated blocks in a flowchart or block diagram.

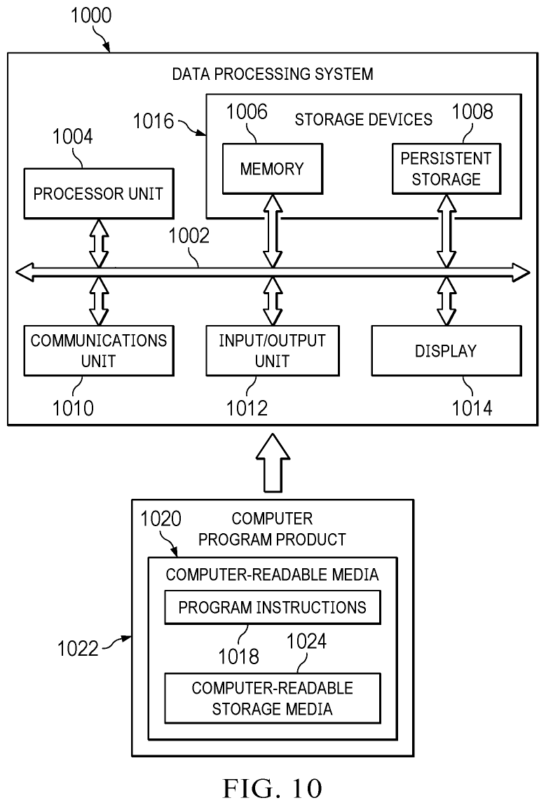

Turning now to FIG. 10, a block diagram of a data processing system is depicted in accordance with an illustrative embodiment. Data processing system 1000 can be used to implement computers and computing devices in computing environment 100 in FIG. 1. Data processing system 1000 can also be used to implement computer system 212 in FIG. 2. In this illustrative example, data processing system 1000 includes communications framework 1002, which provides communications between processor unit 1004, memory 1006, persistent storage 1008, communications unit 1010, input/output (I/O) unit 1012, and display 1014. In this example, communications framework 1002 takes the form of a bus system.

Processor unit 1004 serves to execute instructions for software that can be loaded into memory 1006. Processor unit 1004 includes one or more processors. For example, processor unit 1004 can be selected from at least one of a multicore processor, a central processing unit (CPU), a graphics processing unit (GPU), a physics processing unit (PPU), a digital signal processor (DSP), a network processor, or some other suitable type of processor. Further, processor unit 1004 can be implemented using one or more heterogeneous processor systems in which a main processor is present with secondary processors on a single chip. As another illustrative example, processor unit 1004 can be a symmetric multi-processor system containing multiple processors of the same type on a single chip.

Memory 1006 and persistent storage 1008 are examples of storage devices 1016. A storage device is any piece of hardware that is capable of storing information, such as, for example, without limitation, at least one of data, program instructions in functional form, or other suitable information either on a temporary basis, a permanent basis, or both on a temporary basis and a permanent basis. Storage devices 1016 may also be referred to as computer readable storage devices in these illustrative examples. Memory 1006, in these examples, can be, for example, a random-access memory or any other suitable volatile or non-volatile storage device. Persistent storage 1008 may take various forms, depending on the particular implementation.

For example, persistent storage 1008 may contain one or more components or devices. For example, persistent storage 1008 can be a hard drive, a solid-state drive (SSD), a flash memory, a rewritable optical disk, a rewritable magnetic tape, or some combination of the above. The media used by persistent storage 1008 also can be removable. For example, a removable hard drive can be used for persistent storage 1008.

Communications unit 1010, in these illustrative examples, provides for communications with other data processing systems or devices. In these illustrative examples, communications unit 1010 is a network interface card.

Input/output unit 1012 allows for input and output of data with other devices that can be connected to data processing system 1000. For example, input/output unit 1012 may provide a connection for user input through at least one of a keyboard, a mouse, or some other suitable input device. Further, input/output unit 1012 may send output to a printer. Display 1014 provides a mechanism to display information to a user.

Instructions for at least one of the operating system, applications, or programs can be located in storage devices 1016, which are in communication with processor unit 1004 through communications framework 1002. The processes of the different embodiments can be performed by processor unit 1004 using computer-implemented instructions, which may be located in a memory, such as memory 1006.

These instructions are referred to as program instructions, computer usable program instructions, or computer readable program instructions that can be read and executed by a processor in processor unit 1004. The program instructions in the different embodiments can be embodied on different physical or computer readable storage media, such as memory 1006 or persistent storage 1008.

Program instructions 1018 are located in a functional form on computer readable media 1020 that is selectively removable and can be loaded onto or transferred to data processing system 1000 for execution by processor unit 1004. Program instructions 1018 and computer readable media 1020 form computer program product 1022 in these illustrative examples. In the illustrative example, computer readable media 1020 is computer readable storage media 1024.

Computer readable storage media 1024 is a physical or tangible storage device used to store program instructions 1018 rather than a medium that propagates or transmits program instructions 1018. Computer readable storage media 1024, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Alternatively, program instructions 1018 can be transferred to data processing system 1000 using a computer readable signal media. The computer readable signal media are signals and can be, for example, a propagated data signal containing program instructions 1018. For example, the computer readable signal media can be at least one of an electromagnetic signal, an optical signal, or any other suitable type of signal. These signals can be transmitted over connections, such as wireless connections, optical fiber cable, coaxial cable, a wire, or any other suitable type of connection.

Further, as used herein, “computer readable media 1020” can be singular or plural. For example, program instructions 1018 can be located in computer readable media 1020 in the form of a single storage device or system. In another example, program instructions 1018 can be located in computer readable media 1020 that is distributed in multiple data processing systems. In other words, some instructions in program instructions 1018 can be located in one data processing system while other instructions in program instructions 1018 can be located in one data processing system. For example, a portion of program instructions 1018 can be located in computer readable media 1020 in a server computer while another portion of program instructions 1018 can be located in computer readable media 1020 located in a set of client computers.

The different components illustrated for data processing system 1000 are not meant to provide architectural limitations to the manner in which different embodiments can be implemented. In some illustrative examples, one or more of the components may be incorporated in or otherwise form a portion of, another component. For example, memory 1006, or portions thereof, may be incorporated in processor unit 1004 in some illustrative examples. The different illustrative embodiments can be implemented in a data processing system including components in addition to or in place of those illustrated for data processing system 1000. Other components shown in FIG. 10 can be varied from the illustrative examples shown. The different embodiments can be implemented using any hardware device or system capable of running program instructions 1018.

Thus, illustrative embodiments provide a computer implemented method, computer system, and computer program product for deprovisioning a virtual machine is provided. In one illustrative example, a number of processor units initializes a deprovisioning agent within the virtual machine. The number of processor units monitors a set of metrics in the virtual machine using the deprovisioning agent. The number of processor units deprovisions the virtual machine using the deprovisioning agent in response to the set of metrics meeting a set of criteria for deprovisioning the virtual machine.

As a result, the use of a deprovisioning agent does not require network connectivity outside of the virtual machine. As a result, a simplified set up occurs in being able to monitor the virtual machine to determine when to deprovision the virtual machine. Further, a lower security risk is present because of a reduced attack surface in which virtual machine and components within the virtual machine that monitor and deprovision the virtual machine last for shorter period of time as compared to other techniques. In addition, lower operational costs are present because the deprovisioning agent does not have to be maintained beyond the life of the virtual machine. A lower use of resources is also present and the deprovisioning agent avoids bottlenecks resulting from using centralized controllers with large numbers of virtual machines.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component can be configured to perform the action or operation described. For example, the component can have a configuration or design for a structure that provides the component an ability to perform the action or operation that is described in the illustrative examples as being performed by the component. Further, to the extent that terms “includes”, “including”, “has”, “contains”, and variants thereof are used herein, such terms are intended to be inclusive in a manner similar to the term “comprises” as an open transition word without precluding any additional or other elements.

The descriptions of the various embodiments of the present invention have been presented for purposes of illustration, but illustration but are not intended to be exhaustive or limited to the embodiments disclosed. Not all embodiments will include all of the features described in the illustrative examples. Further, different illustrative embodiments may provide different features as compared to other illustrative embodiments. Many modifications and variations will be apparent to those of ordinary skill in the art without departing from the scope and spirit of the described embodiment. The terminology used herein was chosen to best explain the principles of the embodiment, the practical application or technical improvement over technologies found in the marketplace, or to enable others of ordinary skill in the art to understand the embodiments disclosed here.

What is claimed is:

1. A computer implemented method for deprovisioning a virtual machine, the computer implemented method comprising:
initializing, by a number of processor units, a deprovisioning agent within the virtual machine;
monitoring, by the number of processor units, a set of metrics in the virtual machine using the deprovisioning agent; and
deprovisioning, by the number of processor units, the virtual machine using the deprovisioning agent in response to the set of metrics meeting a set of criteria for deprovisioning the virtual machine.

2. The computer implemented method of claim 1, wherein initializing, by the number of processor units, the deprovisioning agent comprises:
installing, by the number of processor units, the deprovisioning agent in the virtual machine;
retrieving, by the number of processor units, a set of rules implementing the set of criteria from a configuration repository; and
configuring, by the number of processor units, the deprovisioning agent using a set of rules retrieved from the configuration repository.

3. The computer implemented method of claim 1 further comprising:
creating, by the number of processor units, a snapshot of the virtual machine using deprovisioning agent prior to the virtual machine being deprovisioned in response to meeting the set of criteria for deprovisioning the virtual machine.

4. The computer implemented method of claim 1, wherein monitoring, by the number of processor units, the virtual machine comprises:
observing, by the number of processor units, execution behavior of the virtual machine using a set of watchers; and
monitoring, by the number of processor units, the set of metrics generated by the set of watchers observing the execution behavior using the deprovisioning agent.

5. The computer implemented method of claim 1, wherein deprovisioning, by the number of processor units, the virtual machine comprises:
starting, by the number of processor units, a grace period in response to the set of metrics meeting the set of criteria for deprovisioning the virtual machine;
deprovisioning, by the number of processor units, the virtual machine using the deprovisioning agent in response to the grace period ending.

6. The computer implemented method of claim 1, wherein the set of metrics is selected from at least one of process IDs, incoming traffic on a port, processor usage, memory usage, input/output operations, or TCP/IP connections.

7. The computer implemented method of claim 1, wherein the virtual machine is in a serverless computing system.

8. A computer system comprising:
a number of processor units, wherein the number of processor units executes program instructions to:
initialize a deprovisioning agent within a virtual machine;
monitor a set of metrics in the virtual machine using the deprovisioning agent; and
deprovision the virtual machine using the deprovisioning agent in response to the set of metrics meeting a set of criteria for deprovisioning the virtual machine.

9. The computer system of claim 8, wherein as part of initializing the deprovisioning agent, the number of processor units further executes the program instructions to:
install the deprovisioning agent in the virtual machine;
retrieve a set of rules implementing the set of criteria from a configuration repository; and
configure the deprovisioning agent using a set of rules retrieved from the configuration repository.

10. The computer system of claim 8, wherein the number of processor units further executes the program instructions to:
create a snapshot of the virtual machine using deprovisioning agent prior to the virtual machine being deprovisioned in response to meeting the set of criteria for deprovisioning the virtual machine.

11. The computer system of claim 8, wherein as part of monitoring the virtual machine, the number of processor units further executes the program instructions to:
observe execution behavior of the virtual machine using a set of watchers; and
monitor the set of metrics generated by the set of watchers observing the execution behavior using the deprovisioning agent.

12. The computer system of claim 8, wherein as part of deprovisioning the virtual machine, the number of processor units further executes the program instructions to:
start a grace period in response to the set of metrics meeting the set of criteria for deprovisioning the virtual machine;
deprovision the virtual machine using the deprovisioning agent in response to the grace period ending.

13. The computer system of claim 8, wherein the set of metrics is selected from at least one of process IDs, incoming traffic on a port, processor usage, memory usage, input/output operations, or TCP/IP connections.

14. The computer system of claim 8, wherein the virtual machine is in a serverless computing system.

15. A computer program product for deprovisioning a virtual machine, the computer program product comprising a computer readable storage medium having program instructions embodied therewith, the program instructions executable by a computer system to cause the computer system to:
initialize a deprovisioning agent within the virtual machine;
monitor a set of metrics in the virtual machine using the deprovisioning agent; and
deprovision the virtual machine using the deprovisioning agent in response to the set of metrics meeting a set of criteria for deprovisioning the virtual machine.

16. The computer program product of claim 15, wherein as part of initializing the deprovisioning agent, the program instructions are further executable by the computer system to cause the computer system to:
install the deprovisioning agent in the virtual machine;
retrieve a set of rules implementing the set of criteria from a configuration repository; and
configure the deprovisioning agent using a set of rules retrieved from the configuration repository.

17. The computer program product of claim 15, wherein the program instructions are further executable by the computer system to cause the computer system to:
create a snapshot of the virtual machine using deprovisioning agent prior to the virtual machine being deprovisioned in response to meeting the set of criteria for deprovisioning the virtual machine.

18. The computer program product of claim 15, wherein as part of monitoring the virtual machine, the program instructions are further executable by the computer system to cause the computer system to:
observe execution behavior of the virtual machine using a set of watchers; and
monitor the set of metrics generated by the set of watchers observing the execution behavior using the deprovisioning agent.

19. The computer program product of claim 15, wherein as part of deprovisioning the virtual machine, the program instructions are further executable by the computer system to cause the computer system to:
start a grace period in response to the set of metrics meeting the set of criteria for deprovisioning the virtual machine;
deprovision the virtual machine using the deprovisioning agent in response to the grace period ending.

20. The computer program product of claim 15, wherein the set of metrics is selected from at least one of process IDs, incoming traffic on a port, processor usage, memory usage, input/output operations, or TCP/IP connections.
